(19) United States
(12) Patent Application Publication
(10) Pub. No.: US 2017/0231720 A1
(43) Pub. Date: Aug. 17, 2017

(54) PLED DENTAL MATRIX SYSTEM

(71) Applicant: DENTSPLY INTERNATIONAL INC., York, PA (US)

(72) Inventor: Simon P. McDonald, Katikati (NZ)

(73) Assignee: DENTSPLY International Inc., York, PA (US)

(21) Appl. No.: 15/035,100

(22) PCT Filed: Nov. 7, 2014
(86) PCT No.: PCT/US2014/064692

§ 371 Date: May 6, 2016

(51) Int. Cl. A61C 5/85; A61C 13/15; A61C 1/08

(52) U.S. Cl. CPC A61C 5/85; A61C 1/088; A61C 19/003; H01L 51/5012

(57) ABSTRACT

A dental matrix according to the present invention comprises (a) a metal matrix band comprising an internal surface and an external surface; and (b) an organic light emitting diode (OLED) layer disposed on at least a first portion of the internal surface of the metal matrix band, the OLED layer comprising a first electroluminescent polymer disposed between a first and a second electrode layer. Applying an electrical current across the OLED generates light energy suitable for curing dental restoration material with the light energy being applied from the interproximal space.

### FIELD OF THE INVENTION

This invention relates generally to the field of dentistry and more specifically to dental matrix devices utilized in conjunction with fillings in the interproximal areas between adjacent teeth.

### BACKGROUND OF THE INVENTION

Matrices and the use of matrix systems are well known and widely utilized in restorative dentistry. There are many types of matrices available. They are generally made entirely of metal or plastic and are sectional or circumferential bands.

During the restoration of an inter-proximal cavity, the matrix band is secured around the tooth and cavity and forms a mold. This mold is filled with composite material and the composite is light cured. The difficulty with curing an inter-proximal restoration is that once the metal matrix band is wrapped around the tooth, the matrix band does not allow horizontal curing of the composite at the gingivo-proximal tooth surface. It has to be cured from above and this can lead to incomplete curing of the composite resin. When this occurs, composite resin can adhere to the metal matrix rather than the tooth and detach from the restoration when the matrix is removed. The restoration must then be re-done or repaired.

A polymer-based light emitting diode (PLED) is a device that consists of an electroluminescent conductive polymer sandwiched between an anode and a cathode on a substrate. An electrical voltage applied between the electrodes will cause the polymer to glow. These PLED devices are flexible and can be coated on metal surfaces.

Prior art exists of metal matrices with one or two open areas covered with a membrane of transparent material and of matrices with illuminating ports with port covers. These open areas and ports cover a relatively large area of the matrix, They are also very thin and may result in restorations with poor anatomical form. Accordingly, one object of the present invention is to provide a means of effectively forming and light curing interproximal composite restorations. The device is a system that consists of a PLED dental matrix along with a pin-tweezer-type electrical connector.

### SUMMARY OF THE INVENTION

The claimed invention, as described herein, provides the dentist with a means of firmly retaining the composite material within the inter-proximal or gingivo-proximal restoration with a metallic matrix. It also allows direct horizontal curing of composite material along with gingivo-proximal tooth surface. The dental matrix according to the present invention comprises (a) a metal matrix band comprising an internal surface and an external surface; and (b) an organic light emitting diode (OLED) layer disposed on at least a first portion of the internal surface of the metal matrix band, the OLED layer comprising a first electroluminescent polymer disposed between a first and a second electrode layer. The OLED layer may be a polymer-based light emitting diode (PLED) wherein the first electroluminescent layer is selected from the group consisting of poly (p-phenylene vinylene), polyfluorene, polyphenylene, and derivatives thereof. The second electrode may also cover substantially all of the internal surface of the dental matrix band or be arranged in a grid pattern and covers less than that all of the internal surface of the dental matrix band. The dental matrix band is a sectional matrix.

In another embodiment of the invention, the dental matrix band electrically couples with an electrified pin-tweezers to apply electrical current across the OLED. The pin tweezers comprises a first and second pin end that are electrical leads to couple with the first and second electrodes. The pin tweezers further comprises a handle with a compartment containing a power source and voltage control circuitry.

### BRIEF DESCRIPTION OF DRAWINGS

FIG. 1 is an elevation view of a dental matrix band in accordance with the present invention.

FIG. 2 is an elevation view of a dental matrix band in accordance with the present invention.

FIG. 3 is a cross section view of a dental matrix, taken along line 3-3 in FIG. 1.

FIG. 4 is a cross section view of a dental matrix, taken along line 4-4 in FIG. 1.

FIG. 5 is an elevation view of a component of the inventive PLED dental matrix system.

FIG. 6 is a partial elevation view of the component of the inventive PLED dental matrix system shown in FIG. 5.

### DETAILED DESCRIPTION OF THE DRAWINGS

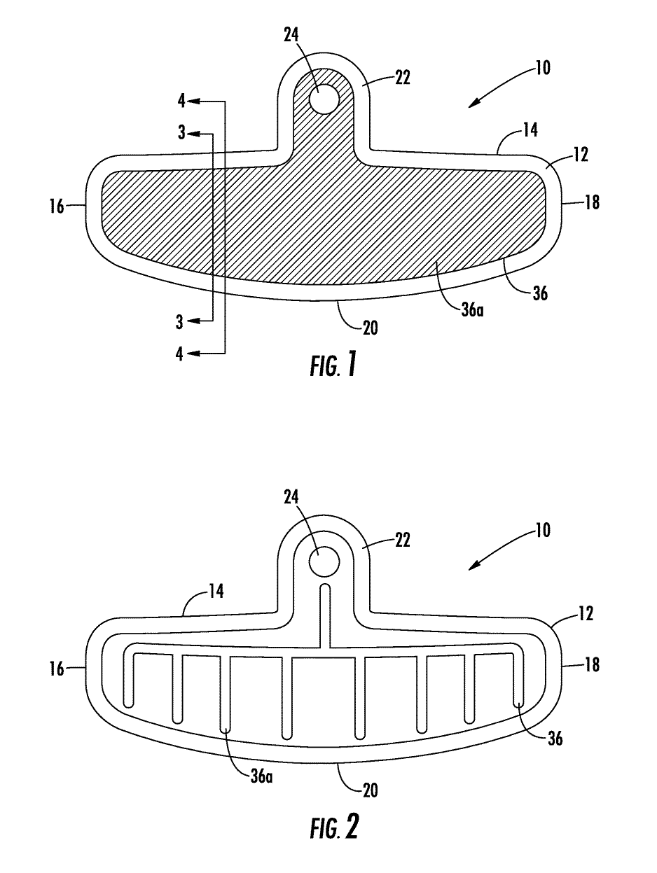

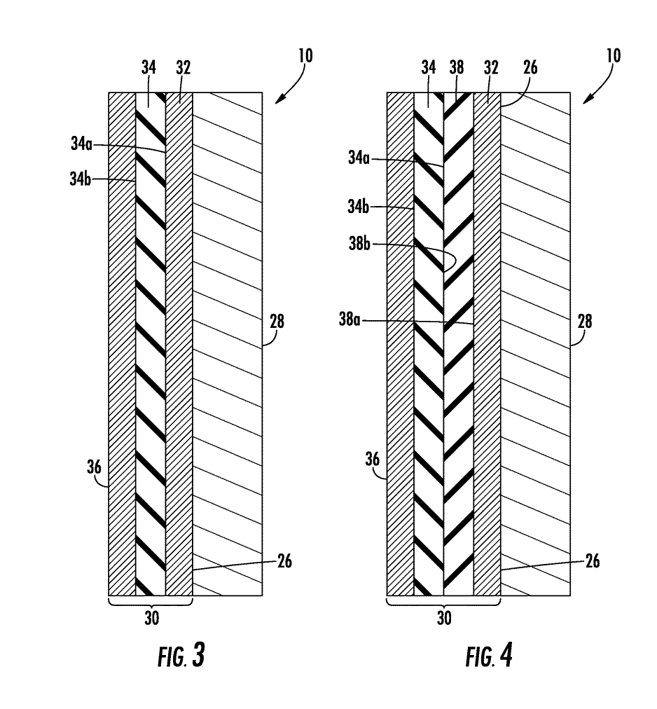

FIGS. 1-5 show various embodiments and components of the present inventive dental matrix system. The embodiment of FIGS. 1 and 2 show the basic form of a dental matrix band 10, generally comprising a matrix body 12 having a top margin 14, opposing sides 16, 18, and bottom margin 20. A tab 22 extends from the matrix body 12 at the top margin 14 and include a through-hole 24. The matrix body has an internal and external surface 26, 28 (best seen in FIG. 3). The internal surface 24 of the matrix body 12 is coated with an organic light emitting diode (OLED) layer 30. In these embodiments the matrix 10 is a circumferential matrix.

As seen in FIG. 3, the OLED layer 30 comprises a first electrode 32, namely the cathode, adjacent the internal surface 24 of the matrix body 12 and an electroluminescent layer 34 sandwiched between the first electrode 32 and a second electrode 36, namely the anode. The electroluminescent layer 34 comprises an emissive layer 34a adjacent the first electrode 32 and a conductive layer 34b adjacent the second electrode 36. In these embodiments, the electroluminescent layer 34 is comprised of a poly (p-phenylene vinylene) (PPV), a polyfluorene, and/or a polyphenylene or derivatives thereof. When the electroluminescent layer 34 is comprised these materials the OLED is a polymer-based light emitting diode (PLED). A significant benefit of this configuration is the ability to provide curing light energy to dental restoration material directly from the interproximal space between adjacent teeth, providing a more consistent curing of the dental restoration materials as compared with the use of a handheld curing light alone. It is contemplated that the curing light energy generated by the inventive dental matrix can be supplemented through the use of a traditional curing light to expose the dental restoration material to light energy from the side and above the restoration area.

FIGS. 1 and 2 also demonstrate alternative second electrode 36 configurations. In FIG. 1, the second electrode 36 is continuously coated as a thin film 36a. In FIG. 2 the second electrode 36 is in a partial grid pattern 36b to ensure the flow of electrons throughout the matrix body 12. The second electrode 36 may remain fully exposed to avoid the need for a dedicated lead to electrically couple to a power source. In these embodiments the material selected for use as the second electrode 36 is transparent to enable the light energy generated by the electroluminescent layer 34 to reach the light-curable dental restoration material. One of ordinary skill in the art will also understand to use transparent material for the cathode should the order of the cathode, anode and electroluminescent layer be reversed and the anode is the first electrode 32 adjacent to the internal surface 24 of the matrix body 12.

Additional layers such as a second luminescent layer 38a and second electron conducting layer 38b may also be present to improve the electron transport properties of LED. FIG. 4 shows this configuration.

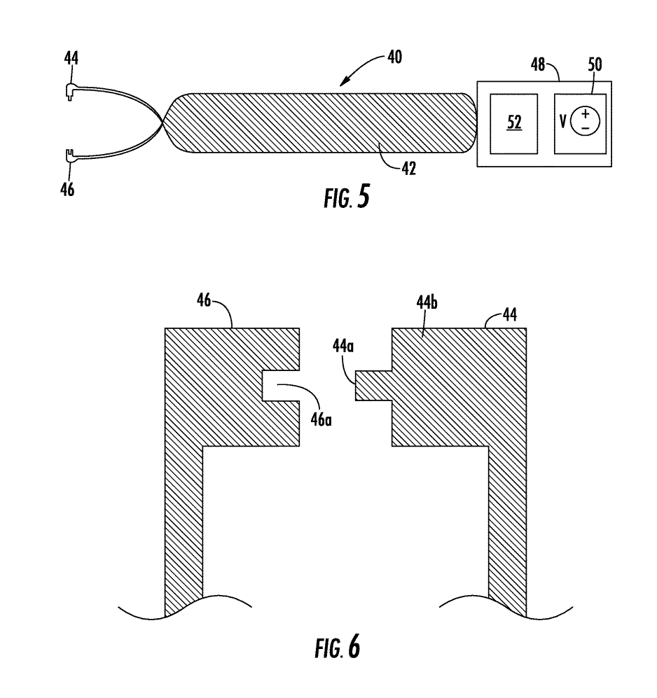

FIGS. 5 and 6 show pin tweezer 40 intended for use in the inventive dental matrix system and, specifically, intended to provide electrical current to the dental matrix of FIGS. 1 and 2. The pin tweezer 40 comprises a handle 42 and first and second pin end 44, 46 and compartment 48 in the handle 42 housing a power source 50 and voltage control circuitry 52 to regulate the electrical current being provided to the dental matrix 10. In this embodiment the power source 50 comprises a battery. The first and second pin ends 44, 46 are configured to electrically couple to the first and second electrodes 32, 36 of the dental matrix 10 (FIG. 1) to apply an electrical current across the OLED. Photoinitiators utilized in dental materials typically absorb light in the 400-500 nm range. Accordingly, the voltage control circuitry 52 will provide current to the OLED sufficient to generate light energy at this wavelength.

As seen in FIG. 6, the first and second pin ends 44, 46 are configured to nest within each other when not in use and when the first pin end 44 is received by the second pin end 46, the interconnected pieces act as insulators when the pin tweezer 40 is not in use. The extension 44a on the first pin end 44 conducts electrical current while the remainder 44b of the first pin end 44 is comprised entirely of an insulating material or is coated in an insulating material. The extension 44a is received by receptacle 46a on the second pin end 46, the receptacle having sidewalls and a bottom. The receptacle 46a is dimensioned large enough to preclude extension 44a from contacting the sidewalls or bottom of the receptacle 46a when the extension inserts into the receptacle. Accordingly, when the receptacle 46a receives the extension 44a there is no electrical contact or electrical communication between the first and second pin ends 44, 46, the circuit is not closed and current from the power source will not flow through the first and second pin ends 44, 46.

The PLED dental matrix system of the present invention works in the following manner:
1. The dentist prepares an inter-proximal cavity on the tooth surface ready to receive the light cured restoration material.
2. The PLED dental matrix is inserted into the inter-proximal space and held securely against the tooth with a retaining device.
3. To ensure there is no leaking of the composite between the matrix band and tooth, a dental wedge may be inserted into the inter-proximal space to hold the band firmly against the tooth surface.
4. The cavity is then filled with composite material.
5. The pin tweezer type connector is clamped to the PLED dental matrix and the current is switched on.
6. The PLED dental matrix produces light in the inter-proximal area.
7. The composite material is cured from the inter-proximal direction.
8. The composite material may also be cured using a curing light from the occlusal direction.

While the present invention has been described in connection with a specific application, this application is exemplary in nature and is not intended to be limiting on the possible applications of this invention. It will be understood that modifications and variations may be effected without departing from the spirit and scope of the present invention. It will be appreciated that the present disclosure is intended as an exemplification of the invention and is not intended to limit the invention to the specific embodiments illustrated and described. The disclosure is intended to cover, by the appended claims, all such modifications as fall within the scope of the claims.

I claim:

1. A dental matrix for use when filling inter-proximal cavities with a dental restorative material, the dental matrix comprising:
(a) a metal matrix band comprising an internal surface and an external surface; and
(b) an organic light emitting diode (OLED) disposed on at least a first portion of the internal surface of the metal matrix band, the OLED layer comprising a first electroluminescent layer disposed between a first and a second electrode layer.

2. The dental matrix of claim 1 wherein the OLED is a polymer-based light emitting diode (PLED).

3. The dental matrix of claim 1 wherein the second electrode is a continuous layer covering substantially all of the internal surface of the dental matrix band.

4. The dental matrix of claim 1 wherein the second electrode is arranged in a grid pattern and covers less than that all of the internal surface of the dental matrix band.

5. The dental matrix of claim 1 wherein the first electroluminescent layer is comprised of a first emissive layer and a first conductive layer and the first emissive and first conductive layers are comprised of material selected from the group consisting of poly (p-phenylene vinylene), polyfluorene, polyphenylene, and derivatives thereof.

6. The dental matrix of claim 1 wherein the second electrode is exposed.

7. The dental matrix of claim 1 wherein the matrix band is a sectional matrix.

8. The dental matrix of claim 1 wherein the first electroluminescent layer is comprised of a first emissive layer and a first conductive layer and the OLED further comprises a second emissive layer and a second conductive layer.

9. The dental matrix of claim 1 wherein the OLED is configured to generate light energy in the range of 400-500 nanometers.

10. A dental matrix system for use when filling inter-proximal cavities with a light-cured dental restorative material, the dental matrix system comprising:
(a) a dental matrix comprising a thin metal matrix band comprising an internal surface and an external surface; and an organic light emitting diode (OLED) layer disposed on at least a first portion of the internal surface of the thin metal matrix band, the OLED layer comprising a first electroluminescent layer disposed between a first and a second electrode layer; and
(b) a power source comprising a first electrical lead configured to electrically couple to the first electrode of the OLED layer and a second lead configured to electrically couple to the second electrode of the OLED to apply electrical current to the dental matrix band and activate the OLED layer.

11. The dental matrix system of claim 10 wherein the OLED is a polymer-based light emitting diode (PLED).

12. The dental matrix system of claim 10 wherein the second electrode of the OLED is a continuous layer covering substantially all of the internal surface of the dental matrix band.

13. The dental matrix system of claim 10 wherein the second electrode of the OLED is arranged in a grid pattern and covers less than that all of the internal surface of the dental matrix band.

14. The dental matrix system of claim 10 wherein the first electroluminescent layer is comprised of a first emissive layer and a first conductive layer and the first emissive and first conductive layers are comprised of material selected from the group consisting of poly (p-phenylene vinylene), polyfluorene, polyphenylene, and derivatives thereof.

15. The dental matrix system of claim 10 wherein the matrix band is a sectional matrix.

16. The dental matrix system of claim 10 wherein the power source comprises a pin tweezer with a first and second pin end wherein the first pin end comprises the first electrical lead and the second pin end comprises the second electrical lead.

17. The dental matrix system of claim 16 wherein the pin tweezer comprises a handle with a storage compartment configured to store the power source and a voltage control circuit.

18. The dental matrix system of claim 11 wherein the power source comprises a battery.

19. The dental matrix system of claim 11 wherein the second electrode is fully exposed.

20. The dental matrix system of claim 11 wherein the first electroluminescent layer is comprised of a first emissive layer and a first conductive layer and the OLED further comprises a second emissive layer and a second conductive layer.

21. The dental matrix system of claim 11 wherein the power source is configured to apply electrical current across the OLED sufficient to generate light energy in the range of 400-500 nanometers.

22. The dental matrix system of claim 16 wherein the first electrical lead of the first pin end is comprised of a first extension in the first pin end and the second pin end comprises a receptacle to receive the first extension, the receptacle having sidewalls and a bottom with a depth and width to receive the first extension and preclude contact of the first extension with the sidewalls or bottom.

23. The dental matrix system of claim 22 wherein the first pin end is comprised of an insulating material precluding electrical contact with the second pin end when the first extension of the first pin end is received by the receptacle on the second pin end.

24. The dental matrix system of claim 22 wherein the first pin end is covered with an insulating material precluding electrical contact of the first pin end with the second pin end when the first extension of the first pin end is received by the receptacle on the second pin end.

25. An electrified dental instrument comprising a pin tweezer in electrical communication with a power source, the pin tweezer having a first pin end comprising a first electrical lead and a second end comprising a second electrical lead.

26. The electrified dental instrument of claim 25 wherein the pin tweezer further comprises a handle and a storage compartment configured to receive a power supply and voltage control circuit.

27. The electrified dental instrument of claim 25 wherein the first electrical lead of the first pin end is comprised of a first extension in the first pin end and the second pin end comprises a receptacle to receive the first extension, the receptacle having sidewalls and a bottom with a depth and width to receive the first extension and preclude contact of the first extension with the sidewalls or bottom.

28. The electrified dental instrument of claim 27 wherein the first pin end is comprised of an insulating material precluding electrical contact with the second pin end when the first extension of the first pin end is received by the receptacle on the second pin end.

29. The electrified dental instrument of claim 27 wherein the first pin end is covered with an insulating material precluding electrical contact of the first pin end with the second pin end when the first extension of the first pin end is received by the receptacle on the second pin end.
